(19) United States
(12) Patent Application Publication
(10) Pub. No.: US 2013/0151514 A1
(43) Pub. Date: Jun. 13, 2013

(54) EXTRACTING TIPS

(71) Applicants: Aristides Gionis, Barcelona (ES); Antti Ukkonen, Barcelona (ES); Ingmar Weber, Barcelona (ES)

(72) Inventors: Aristides Gionis, Barcelona (ES); Antti Ukkonen, Barcelona (ES); Ingmar Weber, Barcelona (ES)

(73) Assignee: Yahoo! Inc., Sunnyvale, CA (US)

(21) Appl. No.: 13/316,413

(22) Filed: Dec. 9, 2011

(51) Int. Cl. G06F 17/30

(52) U.S. Cl. 707/730; 707/771; 707/723; 707/E17.014

(57) ABSTRACT

Embodiments disclosed herein may relate to extracting tips from online sources and/or selecting tips for display to a user on a computing platform.

### BACKGROUND

1. Field

Subject matter disclosed herein may relate to extracting tips from online sources and/or selecting tips for display to a user on a computing platform.

2. Information

With networks, such as the Internet gaining popularity, and with a vast multitude of pages, other documents, media content, applications, etc., hereinafter referred to generally as content, becoming available to users via the World Wide Web (web), it may be desirable to provide efficient or streamlined approaches to gather or display content that may be desirable or useful, such as to a user. Internet-related business entities, such as Yahoo!, for example, may provide a wide range of content via the Web. In some circumstances, challenges may be faced in determining which content, for example, to display via a web page.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a flow diagram illustrating an example process for selecting and/or displaying a tip in response to a query in accordance with an embodiment.

FIG. 2 is a flow diagram illustrating an example process for detecting “how-to” queries in accordance with an embodiment.

FIG. 3 is a flow diagram illustrating an example process for extracting tips from online sources in accordance with an embodiment.

FIG. 4 is an illustration depicting an example system for generating tips in accordance with an embodiment.

FIG. 5 is an illustration of an example display depicting a web page including tips generated in response to a how-to query, in accordance with an embodiment.

FIG. 6 is an illustration of an example display depicting a web page including a tip generated in response to a search query, in accordance with an embodiment.

FIG. 7 is an illustration of an example display depicting a web page including tips generated in response to a click in accordance with an embodiment.

FIG. 8 is a block diagram illustrating an example system comprising a plurality of computing devices coupled via a network in accordance with an embodiment.

Reference is made in the following detailed description to the accompanying drawings, which form a part hereof, wherein like numerals may designate like parts throughout to indicate corresponding and/or analogous aspects. It will be appreciated that elements illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from the scope of claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

As mentioned above, Internet-related business entities such as Yahoo!, for example, may provide a wide range of information, applications, and/or other content that may be available to users via the Web. In some circumstances, challenges may be faced in determining which content, for example, to gather or display, such as to a user.

In an embodiment, an example system and/or process may comprise extracting, storing, and/or displaying, hereinafter referred to generally as extracting, content related to advice, suggestions, and/or warnings at least in part in response to receiving user-generated text, for example. Content may be provided, such as to one or more users, in the form of one or more “tips”. As used herein, a “tip” may refer to advice, suggestion(s), and/or warning(s) content that may be actionable or understandable by a user without additional external content. It is, of course, understood that content typically exists as electrical signals, such as during transmission or reception, or as physical states, such as while stored in memory. A tip may be differentiated from other types of online content in that a tip may be associated with a “how-to” query, in an embodiment. For example, a tip provided to a user in response to a query “how to zest a lime without a zester” may comprise “to zest a lime if you don't have a zester: use a cheese grater,” In an embodiment, a tip may comprise a tip goal and a tip suggestion, forming a tip goal/suggestion pair. For the example presented above, an example tip goal may comprise “to zest a lime if you don't have a zester.” Also, for the example presented above, an example tip suggestion may comprise “use a cheese grater,” Of course, this is merely an example tip, and claimed subject matter is not limited in scope in this respect. Also, in an embodiment, a tip may comprise a relatively short character string to enable convenient display on mobile devices, for example. For an additional example, a tip may comprise a text message of no more than one hundred sixty characters, in an embodiment.

Tips may be extracted without human intervention, referred to herein as automatically, from user-generated online content. In an embodiment, one or more tips may be extracted from a database, such as from Yahoo! Answers, for example. In this context, the term online is intended to refer to content made available to multiple participants via a communications network. One example, of course, includes the Worldwide Web. One or more tips may also be generated from content provided by users directly, and/or further may be stored for retrieval and/or display, in an embodiment. Claimed subject matter is not limited in scope in these respects, however. Additionally, in an embodiment, a tip may comprise relatively concise content, rather than more elaborate content. Conventionally, a search engine may return one or more links to one or more web pages that may include a relatively large amount of content at least in part in response to a user searching on a query term. Content conventionally returned to a user in response to a query may include types of content other than, or in addition to, “how-to” content. By contrast, a tip may communicate actionable or immediately understandable “how-to” content in a more concise fashion. For another example, at least in part in response to a user inputting a query “change default font ms word”, a tip goal/suggestion pair comprising “to change the default font in Microsoft Word: go to format-menu and select ‘font’ then select your font and then click on the ‘default’ button” may be displayed. Again, claimed subject matter is not limited in scope in this respect.

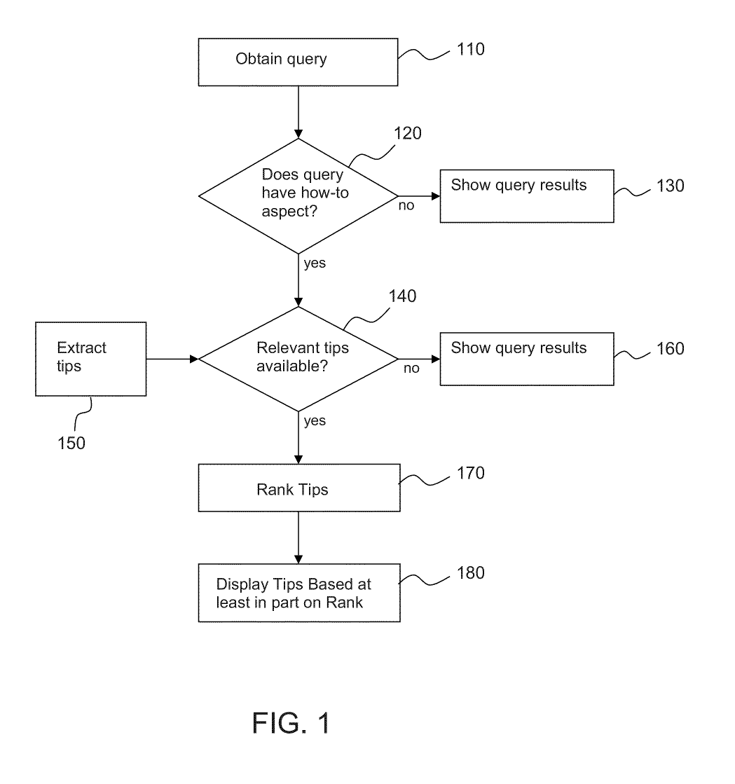

FIG. 1 is a flow diagram illustrating an example process for selecting and/or displaying a tip in response to a query in accordance with an embodiment. In general, for an embodiment, a process in accordance with claimed subject matter may comprise identifying if a user query comprises a “how-to” query for which it may be desirable to display a tip as a response to a query. An example embodiment in accordance with claimed subject matter may further comprise extracting tips from online resources and may further comprise populating one or more databases with useful or desirable tips. Additionally, an example embodiment in accordance with claimed subject matter may comprise retrieving one or more tips for a given “how-to” query.

For an example embodiment depicted in FIG. 1, a query may be received at block 110. In an embodiment, a query may be input by a user utilizing a browser executed on a computing platform. In another embodiment, a query may be rived from user browsing behavior. For example, a user may click on a link to a web page, and content related to the selected web page may be utilized to generate a query. However, claimed subject matter is not limited in this respect.

At block 120, a determination may be made as to whether a query comprises a “how-to” aspect. As used herein, a query having a “how-to” aspect may comprise a query that may be satisfied by content that may be actionable or understandable by a user without additional external content. In an embodiment, a query may be said to comprise a “how-to” aspect if a user is not sure how to solve a particular problem or perform a particular task and may be looking for content, although claimed subject matter is not limited in scope in this respect. Also in an embodiment, if a query is navigational, such as providing a uniform resource locator (URL) or asking how to find a particular website, a query may not be considered to be a “how-to” query, although again claimed subject matter is not limited in scope in this respect.

At least in part in response to a determination that a query does not have a “how-to” aspect, conventional query results may be shown, such as to a user at block 130, in an embodiment. However, at least in part in response to a query being determined to comprise a “how-to” aspect, a determination may be made at block 140 as to whether one or more relevant tips may be available to be displayed. In an embodiment, a pool of potential tips may be provided by an example process to extract tips, for example as depicted at block 150.

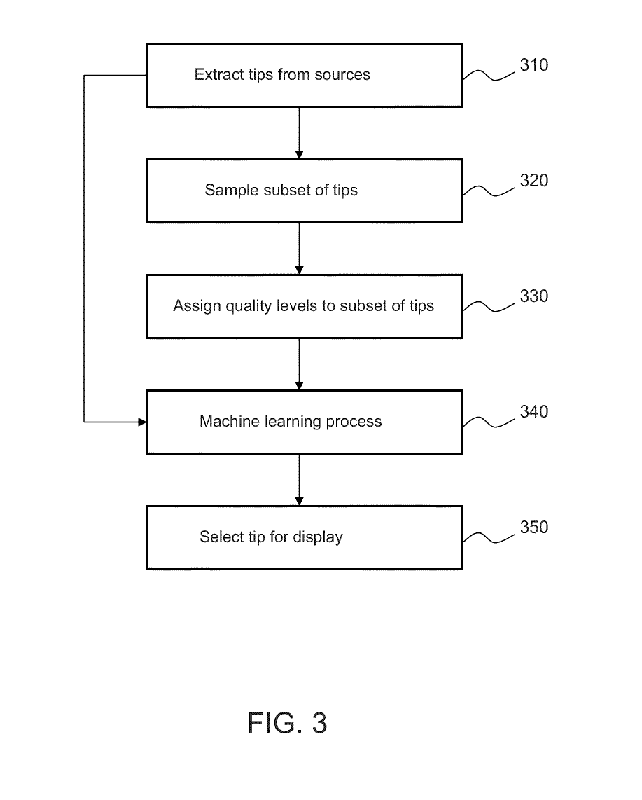

In an embodiment, conventional query results may be shown to a user at block 160 at least in part in response to no relevant tips being determined to be available at block 140. Also in an embodiment, one or more tips may be ranked at block 170 at least in part in response to one or more relevant tips being determined to be available. Example techniques for determining one or more tips in accordance with one or more embodiments are discussed below in connection with FIG. 3. In an embodiment, a higher ranking tip may be displayed to a user, as depicted at block 180. Embodiments in accordance with claimed subject matter may include all of, more than, or less than blocks 110-180. Also, the order of blocks 110-180 is merely an example order, and claimed subject matter is not limited in scope in these respects.

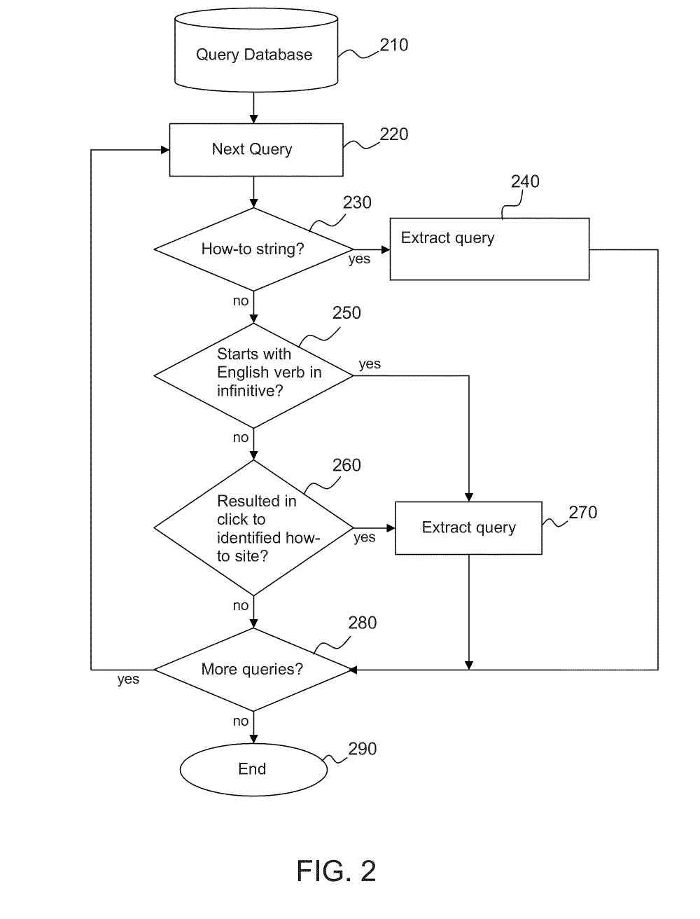

FIG. 2 is a flow diagram illustrating an example process for detecting and/or extracting “how-to” queries in accordance with an embodiment. As used herein, to “extract” a query may relate to patterning a query and/or content related to a query into one or more question/response pairs and storing the one or more question/response pairs in a memory of a computing platform. Query question/response pairs may be utilized in generating “how-to” tips, in an embodiment. For the example process depicted in FIG. 2, a database of queries may be provided at block 210. An example query database may include, for example, a Yahoo! Answers database, in an embodiment. Also, in an embodiment, detection of a “how-to” query may occur in real-time as a user inputs a query. Further, in an embodiment, one or more queries may be derived from user browser behavior, for example. At block 220, a particular query may be selected for testing to determine whether the query comprises a how-to query.

At block 230, a determination may be made as to whether a query comprises a character string including one or more terms identifying the query as a “how-to” query. For example, if a query includes a character string of “how to”, or “how do I”, or “how can I”, the query may be said to comprise a “how-to” query. “How-to” queries may include, to list merely a few examples, “how to safely extinguish a campfire,” “how do you fix keys on a laptop,” “how to do hair like Audrey Hepburn,” “how to train your dragon,” “how do you make your basement smell better,” and/or “how do convert video formats.” Of course, embodiments in accordance with claimed subject matter are not limited to these specific examples. At least in part in response to a query being determined to comprise a “how-to” character string, a query may be extracted, as depicted at block 240, in an embodiment. Further, in an embodiment, an extracted query may be stored in a database and/or displayed to a user, in an embodiment. As also depicted at block 240, a query may be extracted along with a normalized counterpart of the query. A normalized counterpart of a query may comprise a query with its “how-to” character string removed. For example, a query may comprise “how to safely extinguish a campfire”, and a normalized counterpart may comprise “safely extinguish a campfire”. Both versions of a “how-to” query may be stored in a query database, in an embodiment.

In an embodiment, a further determination may be made at block 250 as to whether a query begins with and/or contains an English verb in its infinitive form at least in part in response to a determination that a query is determined to not comprise a “how-to” character string at block 230. Also in an embodiment, a query may be partitioned according to non-word characters. First words of individual partitions of a query may be checked to determine if the word comprises an English verb in infinitive form. Examples of queries or query partitions that may include English verbs in infinitive form may include “play my music on tool bar radio” or “make your own oversized bag,” for example. Of course, these are merely example queries and/or query partitions, and claimed subject matter is not limited in scope in this respect. Also, in an embodiment, a query may be extracted at block 270 at least in part in response to a determination that a query and/or a query partition begins with an English verb in infinitive form. Again, an extracted query may be stored in a query database, in an embodiment, although claimed subject matter is not limited in scope in this respect.

Further, in an embodiment, an additional determination may be made at block 260 with respect to whether a query may have resulted in a selection of a link by a user to an identified “how-to” web site. In an embodiment, factors that may be considered in determining whether a web site comprises a “how-to” web site may include, for example, an amount of “how-to” queries that are submitted to a web site or an amount of non-“how-to” queries submitted to a web site. At least in part in response to a determination that a query may have resulted in a selection of a link to an identified “how-to” web site, a query may be extracted at block 270. However, for an embodiment, navigational queries may be excluded from extraction and/or storage. In an embodiment, a query may be determined to be navigational at least in part in response to one or more tokens of a normalized query being present in a host name. That is, for an embodiment, a query may be considered to comprise a navigational query at least in part in response to a query reasonably closely matching a name of a web site.

As depicted at block 280, if additional queries remain to be checked for “how-to” aspects, processing may return to block 220 where a new query may be selected for processing. If at block 280 at determination is made that no queries remain, processing may end at block 290. Embodiments may include all of, more than, or less than blocks 210-290. Also, the order of blocks 210-290 is merely an example order, and claimed subject matter is not limited in scope in these respects.

FIG. 3 is a flow diagram illustrating an example process for extracting tips from online sources in accordance with an embodiment. At block 310, tips may be extracted from one or more online sources. For example, one or more tips may be gathered from a database associated with a Yahoo! Answers website, although claimed subject matter is not limited in scope in this respect. In an embodiment, question/response pairs stored in a database may be examined to determine suitability for use as tip goal/suggestion pairs. Also in an embodiment, a question stored in an online database may be associated with more than one response. In some cases, responses may be provided by users, and it may be desirable to determine a response for use from among one or more responses for an individual question so that desirable or useful tips are generated. In an embodiment, for one or more online question/response databases, users may provide feedback with respect to which responses to a particular question may be most correct. Feedback information may be utilized, in an embodiment, to identify more desirable or more useful tips, for example.

Additionally, in an embodiment, extracted question/response pairs may be checked to ensure that both question and response are provided in a specified language, such as English, for example. In an example embodiment, a question and/or response not provided in English may disqualify a particular question/response pair from being utilized to generate a tip. Further, in an embodiment, a determination may be made as to whether individual question/response pairs include literal “how-to” questions. For example, a question may be considered to comprise a literal “how-to” question if the question starts with “how to,” “how do I” or “how can I,” an embodiment. Additionally, in an example embodiment, a determination may be made as to whether responses of individual question/response pairs start with a verb. In an embodiment, if a response does not start with a verb, it may be disqualified as a potential tip or involve additional processing.

In an embodiment, performing filtering operations such as those described above may result in a set of question/response pairs to which syntactic transformations may be applied to construct a set of tips in a form of “X:Y” wherein “X” represents a tip goal and wherein “Y” represents a tip suggestion. In an embodiment, a question may be transformed into a tip goal at least in part by converting a question to an active piece of advice. For example, a how-to question may be converted into a tip by replacing “how (to/do/I/can I)” with “to”, in an embodiment. For example, a “how-to” question such as “How can I improve my X?” may be converted into a tip goal of “To improve your X: . . . ” in an embodiment.

In an embodiment, In an embodiment, a subset of tips may be sampled at block 320, and a quality level may be assigned to individual tips from the sampled subset of tips at block 330. In an embodiment, one or more human individuals may examine one or more tips from a sampled subset of tips and may assign quality levels to individual tips. In an embodiment, human workers may evaluate a sampled subset of tips in order to determine whether individual tips are “Very Good”, “OK”, or “Bad”, for example. In an embodiment, a worker may be instructed to assign a quality level of “Very Good” to a particular tip if a tip is actionable or understandable by user without additional external information. Also, in an embodiment, a worker may be instructed to assign a quality level of “OK” to a particular tip if a tip may comprise an opinion and/or if a tip may be of questionable accuracy. Further, in an embodiment, a worker may be instructed to assign a quality level of “Bad” to a particular tip if a tip is determined by a worker to be a joke, unintelligible, insulting, and/or clearly incorrect, and/or if a worker discerns that details are missing, for example. Of course, these are merely example criteria that one or more workers may utilize to assign one or more quality levels to one or more tips, and claimed subject matter is not limited in cope in this respect. Also, quality levels of “Very Good”, “OK”, and/or “Bad” are merely example quality levels, and again, claimed subject matter is not limited in scope in these respects.

In an embodiment, a machine learning process may be utilized to avoid human intervention at least in part so that a process may assign a quality level to one or more tips. Also in an embodiment, quality levels assigned by human individuals to a sampled subset of tips may be utilized to train a machine learning process that may be utilized to assign quality levels to one or more tips without human intervention, in accordance with an embodiment. Embodiments in accordance with claimed subject matter are not limited to any particular machine learning processes or techniques. At block 350, a tip may be selected for displaying to a user based, at least in part, on a quality ranking. In an embodiment a better ranked tip may be selected, although claimed subject matter is not limited in scope in this respect. Additionally, a tip may be selected for display to a user based, at least its part, on a determination of which one or more tips are mare closely related to an individual query.

To determine which, if any, tip to present to a user in response to a query, one or more candidate tips may be selected based, at least in part, on whether one or more terms of a query correspond to one or more terms of a tip goal. In an embodiment, a tip may be selected as a candidate tip at least in part in response to a tip goal comprising at least a threshold amount of terms in common with a query. Further, in an embodiment, at least in part in response to selecting one or more candidate tips related to a query, candidate tips may be ranked and one or more higher ranked tips may be selected for display to a user. In an embodiment, candidate tips may be ranked according to an amount of query terms found in a tip goal, although claimed subject matter is not limited in scope in this respect.

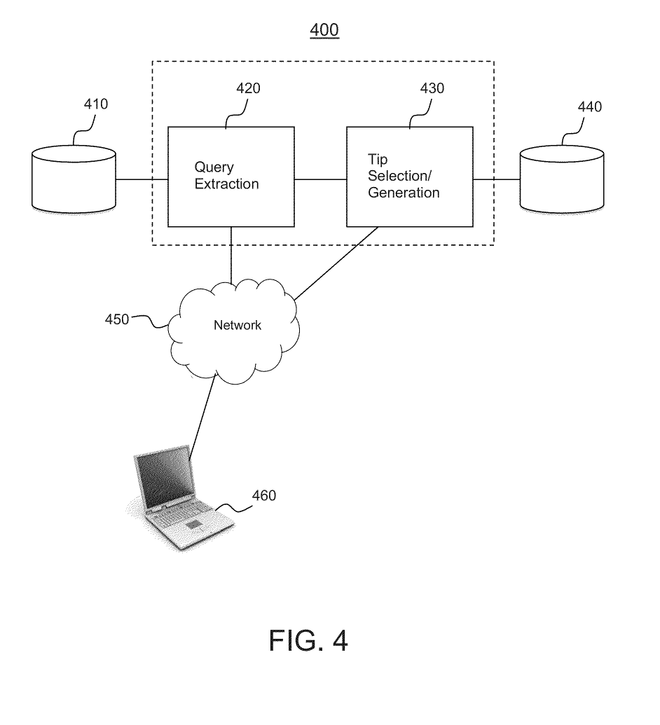

FIG. 4 is an illustration depicting an example system for generating tips in accordance with an embodiment. In an embodiment, a system 400 may comprise a query extraction unit 420 and a tip selection/generation unit 230. A user may interact with a computing platform 460 to submit queries to system 400 via a network 450. In an embodiment, network 450 may comprise the Internet and system 400 may be part of the world-wide web, although claimed subject matter is not limited in these respects.

In an embodiment, query extraction unit 420 may extract “how-to” queries from a database 410 and/or may extract “how-to” queries from content received from computing platform 460. Content received at query extraction unit 420 from computing platform 460 may comprise content from user browsing behavior gathered as a user browses the world-wide web, for example. Additionally, content received at query extraction unit 420 from computing platform 460 may comprise queries submitted by a user to system 400. In an embodiment, queries submitted by a user may comprise “how-to” queries, and/or may comprise other types of queries, such as conventional search queries. At least in part in response to receiving a conventional search query from computing platform 460, query extraction unit 420 may derive content that may allow tip selection/generation unit 430 to provide a us with one or more tips related to a conventional search query. Additionally, in an embodiment, query extraction unit 420 may provide a “how-to” query received from computing platform 460 to tip selection/generation unit 430.

At least in part in response to receiving a “how-to” query from query extraction unit 420, tip selection/generation unit 430 may select one or more appropriate tips from a tip database 440, and may transmit one or more tips to computing platform 460. In an embodiment, tips database 440 may comprise “how-to” tips derived from queries and/or other content provided to tip selection/generation unit 430 from query extraction unit 420. Of course, system 400 is merely an example system, and claimed subject matter is not limited in scope in this respect.

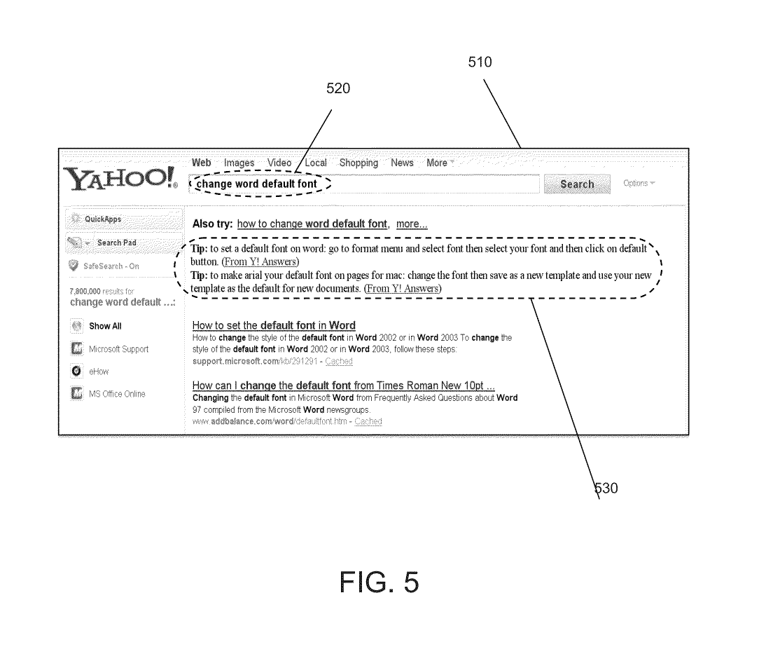

FIG. 5 is an illustration of an example display depicting an example web page 510 including example tips 430 selected in response to a “how-to” query 520, in accordance with an embodiment. As depicted in FIG. 5, tips 530 may be derived from a database, such as Yahoo! Answers, for example. Additionally, for the example depicted in FIG. 5, conventional web search results in the form of hyperlinks may be provided, in an embodiment.

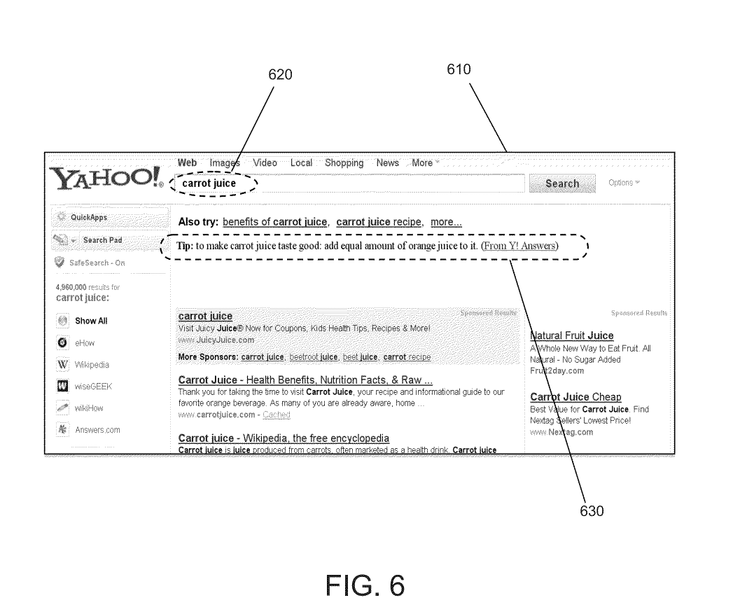

FIG. 6 is an illustration of an example display depicting an example web page 610 including an example tip 630 selected at least in part in response to a conventional search query 620 entered by a user, in accordance with an embodiment. In contrast to the example depicted in FIG. 5, “how-to” tip 630 may be provided at least in part in response to a conventional search query 620, rather than in response to a “how-to” query, such as how-to query 520, for example.

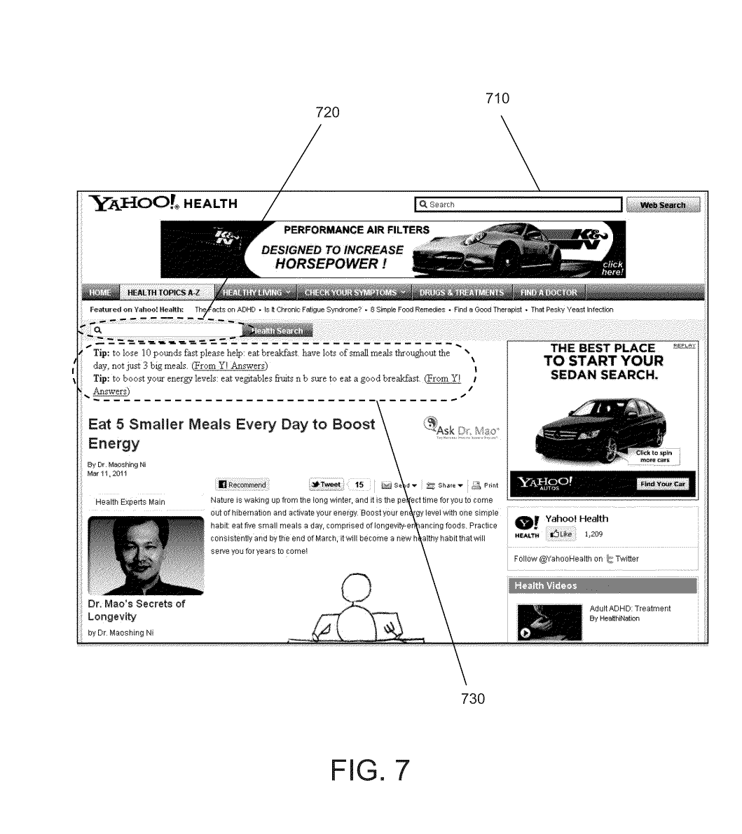

FIG. 7 is an illustration of an example display depicting a web page 710 including example how-to tips 730 selected at least in part in response to a user browsing to web page 710, in accordance with an embodiment. In contrast to the examples depicted in FIGS. 5 and 6, example tips 730 may be selected and/or displayed at least in part in response to user browsing behavior, rather than in response to a query submitted by a user. In an embodiment, example tips 730 may be selected and/or displayed based at least in part on content included in example web page 710.

FIGS. 5-7, discussed above, depict “how-to” tips selected and/or displayed on one or more web pages. However, web pages, queries, and/or tips depicted in FIGS. 5-7 are merely examples, and claimed subject matter is not limited in scope in these respects.

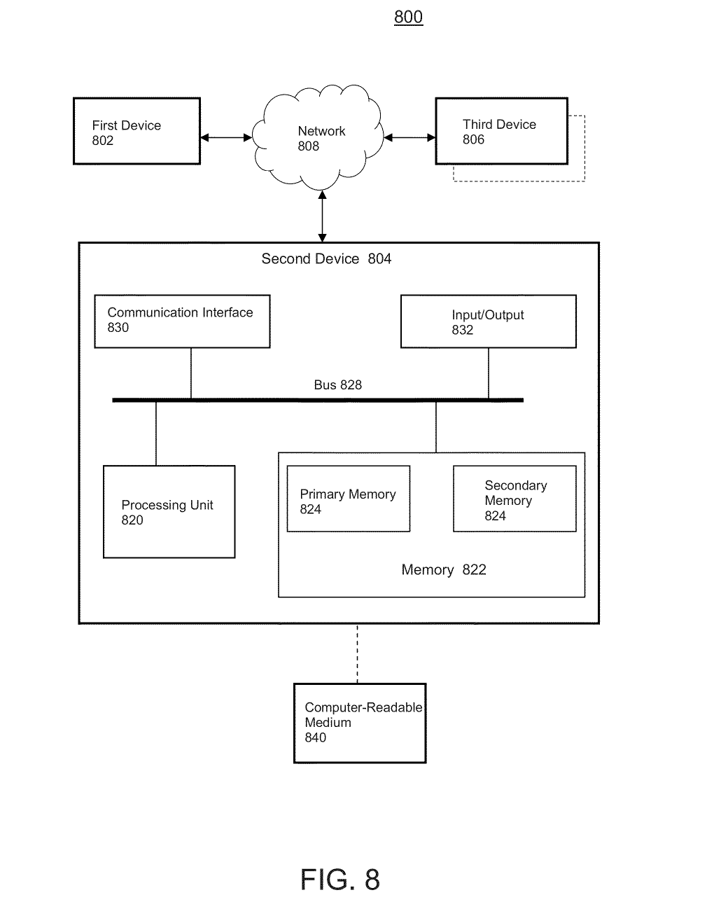

FIG. 8 is a schematic diagram illustrating an exemplary embodiment 800 of a computing environment system that may include one or more devices configurable to implement techniques and/or processes described above in connection with “how-to” queries and/or tips discussed above in connection with FIGS. 1-7, for example. System 800 may include, for example, a first device 802, a second device 804, and a third device 806, which may be operatively coupled together through a network 808.

First device 802, second device 804 and third device 806, as shown in FIG. 8, may be representative of any device, appliance or machine that may be configurable to exchange data over network 808. By way of example but not limitation, any of first device 802, second device 804, or third device 806 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 808, as shown in FIG. 8, is representative of one or more communication links, processes, and/or resources configurable to support the exchange of data between at least two of first device 802, second device 804, and third device 806. By way of example but not limitation, network 808 may include wireless and/or wired communication links, telephone or telecommunications systems, data buses or channels, optical fibers, terrestrial or satellite resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to network 808.

It is recognized that all or part of the various devices and networks shown in system 800, and the processes and methods as further described herein, may be implemented using or otherwise include hardware, firmware, software, or any combination thereof (other than software per se).

Thus, by way of example but not limitation, second device 804 may include at least one processing unit 820 that is operatively coupled to a memory 822 through a bus 828.

Processing unit 820 may be representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof.

Memory 822 may be representative of any data storage mechanism. Memory 822 may include, for example, a primary memory 824 and/or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820.

Secondary memory 826 may include, for example, the same or similar type of memory as primary memory and/or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any medium that can carry and/or make accessible data, code and/or instructions for one or more of the devices in system 800.

Second device 804 may include, for example, a communication interface 830 that provides for or otherwise supports the operative coupling of second device 804 to at least network 808. By way of example but not limitation, communication interface 830 may include a network interface device or card, a modem, a router, a switch, a transceiver, and the like.

Second device 804 may include, for example, an input/output 832. Input/output 832 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 832 may include an operatively configured display, speaker, keyboard, mouse, trackball, touch screen, data port, etc.

The term “computing platform” as used herein refers to a system and/or a device that includes the ability to process and/or store data in the form of signals or states. Thus, a computing platform, in this context, may comprise hardware, software, firmware or any combination thereof (other than software per se). Computing platform 800, as depicted in FIG. 8, is merely one such example, and the scope of claimed subject matter is not limited in these respects. For one or more embodiments, a computing platform may comprise any of a wide range of digital electronic devices, including, but not limited to, personal desktop or notebook computers, high-definition televisions, digital versatile disc (DVD) players or recorders, game consoles, satellite television receivers, cellular telephones, personal digital assistants, mobile audio or video playback or recording devices, or any combination of the above. Further, unless specifically stated otherwise, a process as described herein, with reference to flow diagrams or otherwise, may also be executed and/or controlled, in whole or in part, by a computing platform.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Methodologies described herein may be implemented by various techniques depending, at least in part, on applications according to particular features or examples. For example, methodologies may be implemented in hardware, firmware, or combinations thereof, along with software (other than software per se). In a hardware embodiment, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter.

Some portions of the preceding detailed description have been presented in terms of logic, algorithms and/or symbolic representations of operations on binary states stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm here, and generally, is considered to be a self consistent sequence of operations and/or similar signal processing leading to a desired result. In this context, operations and/or processing involve physical manipulation of physical quantities. Typically, although not necessarily, such quantities may take the form of electrical and/or magnetic signals capable of being stored, transferred, combined, compared or otherwise manipulated as electronic, signals representing content or information. It has proven convenient at times, principally for reasons of common usage, to refer to such signals as bits, data, values, elements, symbols, characters, terms, numbers, numerals, content, information or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, or the like may refer to actions and/or processes of a specific apparatus, such as a special purpose computer or a similar special purpose electronic computing device. In the context of this specification, therefore, a special purpose computer and/or a similar special purpose electronic computing device is capable of manipulating and/or transforming signals, typically represented as physical electronic and/or magnetic quantities within memories, registers, and/or other information storage devices, transmission devices, or display devices of the special purpose computer and/or similar special purpose electronic computing device. In the context of this particular patent application, the term “specific apparatus” may include a general purpose computer once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state xray comprise a physical change and/or transformation in magnetic orientation or a physical change and/or transformation in molecular structure, such as from crystalline to amorphous or vice-versa. In still other memory devices, a change in physical state may involve quantum mechanical phenomena, such as, superposition, entanglement, or the like, which may involve quantum bits (qubits), for example. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A computer-readable (storage) medium typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has be illustrated and/or described what are presently considered to be example features, it will be understood by those skilled in the art that various other modifications may be made, and/or equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and/or equivalents thereof.

1. A method, comprising:
determining whether a query comprises a how-to aspect utilizing, at least in part, a server computing platform; and
selecting one or more tips for display at least in part in response to a determination that the query comprises the how-to aspect.

2. The method of claim 1, further comprising:
receiving one or more signals indicative of the query from a client computing platform; and
transmitting one or more signals indicative of the selected one or more tips to the client computing platform at least in part in response to the selecting the one or more tips.

3. The method of claim 1, wherein said determining whether the query comprises the how-to aspect comprises determining whether the query comprises a character string indicative of a how-to aspect.

4. The method of claim 1, wherein said determining whether the query comprises the how-to aspect comprises determining whether the query comprises a verb of a selected language in an infinitive form.

5. The method of claim 4, wherein said determining whether the query comprises the verb comprises partitioning the query into one or more sections and determining whether a first word of the one or more individual sections comprises the verb of the selected language in the infinitive form.

6. The method of claim 1, wherein said determining whether the query comprises the how-to aspect comprises determining whether the query comprises a reference to a previously identified how-to web site.

7. The method of claim 1, wherein said selecting one or more tips comprises extracting one or more tips from a query question/response online database, wherein the one or more tips individually comprise a tip goal/suggestion pair.

8. The method of claim 7, wherein said extracting the one or more tips comprises assigning a quality level to individual tips of the one or more tips without human intervention.

9. The method of claim 1, wherein said selecting one or more tips comprises identifying one or more candidate tips and ranking the one or more candidate tips based at least in part on an amount of terms shared between the query and individual tips of the one or more candidate tips.

10. An article, comprising: a computer-readable medium having stored thereon instructions executable by a computing platform to:
determine whether a query comprises a how-to aspect; and
select one or more tips for display at least in part in response to a determination that the query comprises the how-to aspect.

11. The article of claim 10, wherein the computer-readable medium has stored thereon further instructions executable by computing platform to transmit the selected one or more tips.

12. The article of claim 10, wherein the computer-readable medium has stored thereon further instructions executable by the computing platform to determine whether the query comprises the how-to aspect at least in part by determining whether the query comprises a character string indicative of a how-to aspect.

13. The article of claim 10, wherein the computer-readable medium has stored thereon further instructions executable by the computing platform to determine whether the query comprises the how-to aspect at least in part by determining whether the query comprises a verb of a selected language in an infinitive form.

14. The article of claim 13, wherein the computer-readable medium has stored thereon further instructions executable by the computing platform to determine whether the query comprises the verb at least in part by partitioning the query into one or more sections and by determining whether a first word of the one or more individual sections comprises the verb of the selected language in the infinitive form.

15. The article of claim 10, wherein the computer-readable medium has stored thereon further instructions executable by the computing platform to determine whether the query comprises the how-to aspect at least in part by determining whether the query comprises a reference to a previously identified how-to web site.

16. The article of claim 10, wherein the computer-readable medium has stored thereon further instructions executable by the computing platform to select the one or more tips at least in part by extracting one or more tips from a query question/response online database, wherein the one or more tips individually comprise a tip goal/suggestion pair.

17. The article of claim 16, wherein the computer-readable medium has stored thereon further instructions executable by the computing platform to extract the one or more tips at least in part by assigning a quality level to individual tips of the one or more tips.

18. The article of claim 17, wherein the computer-readable medium has stored thereon further instructions executable by the computing platform to select one or more tips at least in part by identifying one or more candidate tips and ranking the one or more candidate tips based at least in part on an amount of terms shared between the query and individual tips of the one or more candidate tips.

19. An apparatus, comprising:
means for determining whether the query comprises a how-to aspect; and
means for selecting one or more tips for display to the user at least in part in response to a determination that the query comprises the how-to aspect.

20. The apparatus of claim 19, wherein said means for determining whether the query comprises the how-to aspect comprises means for determining whether the query comprises a character string indicative of a how-to aspect.
